(19) United States
(12) Patent Application Publication
(10) Pub. No.: US 2018/0106193 A1
(43) Pub. Date: Apr. 19, 2018

(54) HIGH OVERALL PRESSURE RATIO GAS TURBINE ENGINE

(71) Applicant: General Electric Company, Schenectady, NY (US)

(72) Inventors: Martin Miles D'Angelo, Boston, MA (US); Stuart Brian Bassler, Belmont, MA (US); Brian Lewis Devendorf, Georgetown, MA (US); Mark Joseph Wagner, Danvers, MA (US)

(21) Appl. No.: 15/292,203

(22) Filed: Oct. 13, 2016

(51) Int. Cl. F02C 3/04; F02C 3/14

(52) U.S. Cl. CPC F02C 3/04; F02C 3/145

(57) ABSTRACT

A gas turbine engine includes a compressor section and turbine section. The gas turbine engine of the present disclosure is a relatively small gas turbine engine, configured to generate less than 2,000 horsepower during peak operations. The compressor section defines an overall compressor ratio of at least 15:1 in order to increase in overall efficiency of the gas turbine engine.

### FIELD OF THE INVENTION

The present subject matter relates generally to a gas turbine engine, or more particularly to a more efficient, relatively small power class gas turbine engine.

### BACKGROUND OF THE INVENTION

A core of an exemplary gas turbine engine generally includes, in serial flow order, a compressor section, a combustion section, and a turbine section. In operation, ambient air is provided to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gasses through the turbine section drives the turbine section.

With relatively small power class aeronautical engines, the compressor section of the core includes a relatively compact compressor, e.g., with three or less stages or compressor rotor blades and fixed stator vanes positioned therebetween. Similarly, the turbine section of relatively small power class aeronautical engines typically includes a high pressure turbine with single stage of turbine rotor blades for driving the compressor. A low pressure turbine is then provided downstream of the high pressure turbine for driving an output shaft, such as a drive shaft to a propeller or other output shaft.

The above configuration, while fairly straight forward, may leave room for improvements from an efficiency standpoint. Accordingly, a relatively small power class aeronautical engine capable of driving an output shaft, while achieving increases in efficiency would be useful.

### BRIEF DESCRIPTION OF THE INVENTION

Aspects and advantages of the invention will be set forth in part in the following description, or may be obvious from the description, or may be learned through practice of the invention.

In one exemplary embodiment of the present disclosure, a gas turbine engine defining an axial direction and a radial direction is provided. The gas turbine engine includes a stage of variable inlet guide vanes, and a compressor section including a compressor located downstream of the stage of variable inlet guide vanes. The compressor section defines an overall compressor ratio of at least 15:1. The gas turbine engine also includes a turbine section located downstream of the compressor section including a high pressure turbine and a low pressure turbine. The high pressure turbine includes at least two stages of turbine rotor blades. The gas turbine engine generates less than 2,000 horsepower during peak operation.

In another exemplary embodiment of the present disclosure, a gas turbine engine is provided. The gas turbine engine defines an axial direction and a radial direction. The gas turbine engine includes a compressor section defining an overall compressor ratio of at least 15:1, and a turbine section located downstream of the compressor section. The turbine section includes a high pressure turbine and a low pressure turbine. The gas turbine engine generates less than 2,000 horsepower during peak operation.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic, cross-sectional view of an exemplary gas turbine engine according to various embodiments of the present subject matter.

FIG. 2 is a perspective view of a turbine rotor blade in accordance with an exemplary embodiment of the present disclosure.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The terms “forward” and “aft” refer to relative positions within a gas turbine engine, with forward referring to a position closer to an engine inlet and aft referring to a position closer to an engine nozzle or exhaust. The terms “upstream” and “downstream” refer to the relative direction with respect to fluid flow in a fluid pathway. For example, “upstream” refers to the direction from which the fluid flows, and “downstream” refers to the direction to which the fluid flows.

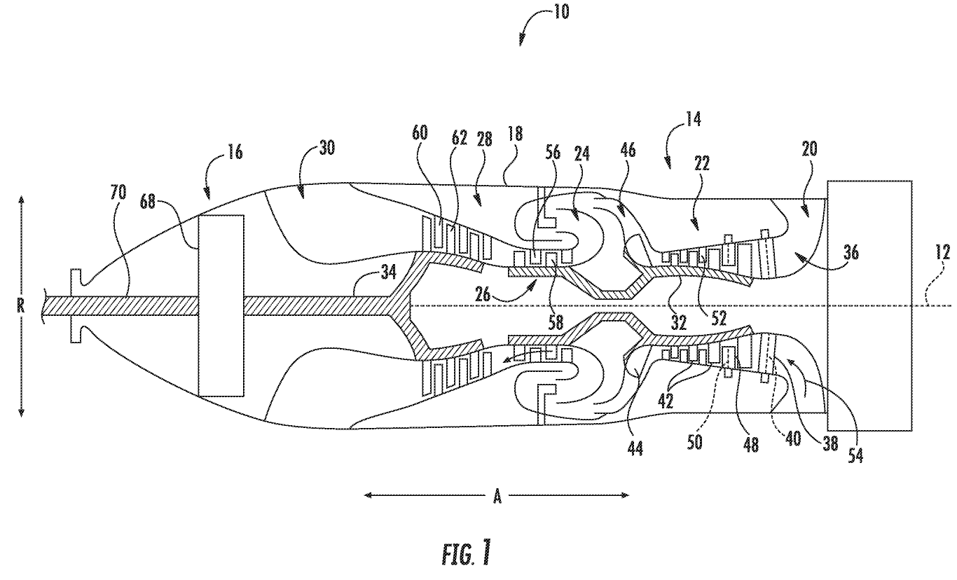

Referring now to the drawings, wherein identical numerals indicate the same elements throughout the figures, FIG. 1 is a schematic, cross-sectional view of a gas turbine engine in accordance with an exemplary embodiment of the present disclosure. More particularly, for the embodiment of FIG. 1, the gas turbine engine is a turboshaft engine, referred to herein as “turboshaft engine 10.” It will be appreciated, however, that in other exemplary embodiments, the turboshaft engine 10 may instead be configured in any other suitable manner. For example, in other exemplary embodiments, the turboshaft engine 10 may instead be configured as a turboprop engine, or any other suitable gas turbine engine.

As shown in FIG. 1, the turboshaft engine 10 defines an axial direction A (extending parallel to a longitudinal centerline 12 provided for reference), a radial direction R, and a circumferential direction (i.e., a direction extending about the axial direction A; not depicted). In general, the turboshaft engine 10 includes a core turbine engine 14 and an output shaft assembly 16.

The exemplary core turbine engine 14 depicted generally includes a substantially tubular outer casing 18 that partially encloses an annular, radial inlet duct 20. The radial inlet duct 20 includes at least a portion extending generally along the radial direction R, and is further configured to turn a direction of an air flow therethrough, such that the resulting airflow is generally along the axial direction A. Additionally, the outer casing 18 encases, in serial flow relationship, a compressor section including a single compressor 22; a combustion section including a reverse flow combustor 24; a turbine section including a high pressure (HP) turbine 26 and a low pressure (LP) turbine 28; and an exhaust section 30. Moreover, the turboshaft engine 10 depicted is a dual-spool engine, including a first, high pressure (HP) shaft or spool 32 coupling the HP turbine 26 to the compressor 22, and a low pressure (LP) shaft or spool 34 coupled to the LP turbine 28, and drivingly connecting the LP turbine 28 to the output shaft assembly 16.

The compressor section, combustion section, turbine section, and exhaust section 30 together define a core air flowpath 36 through the core turbine engine 14. Notably, for the embodiment depicted, the core turbine engine 14 further includes a stage of inlet guide vanes 38 at a forward end of the core air flowpath 36. Specifically, the inlet guide vanes 38 are positioned at least partially within the radial inlet duct 20, the radial inlet duct 20 located upstream of the compressor section, including the compressor 22. More specifically, for the embodiment depicted the compressor section, including the compressor 22, is located downstream of the stage of inlet guide vanes 38. Further, the exemplary stage of inlet guide vanes 38 of FIG. 1 are configured as variable inlet guide vanes 38. The variable inlet guide vanes 38 are each rotatable about a pitch axis 40, allowing for the guide vanes 38 to direct an airflow through the radial inlet duct 20 into the compressor 22 of the compressor section in a desired direction. In certain embodiments, each of the variable inlet guide vanes 38 may be configured to rotate completely about the respective pitch axis 40, or alternatively, each of the plurality of variable inlet guide vanes 38 may include a flap or tail configured to rotate about a respective pitch axis 40. It should be appreciated, however, that in still other exemplary embodiments, each of the plurality of guide vanes may not be configured to rotate about a respective pitch axis 40, and instead may include any other suitable geometry or configuration allowing for a variance in a direction of the airflow over the variable guide vanes 38. Additionally, in other exemplary embodiments, the stage of inlet guide vanes 38 may instead be located at any other suitable location within the radial inlet duct 20.

Furthermore, the compressor 22 of the compressor section includes at least three stages of compressor rotor blades. More specifically, for the embodiment depicted, the compressor 22 of the compressor section includes at least four stages of compressor rotor blades. More specifically still, for the embodiment depicted, the compressor 22 of the compressor section includes four stages of radially oriented compressor rotor blades 42, and an additional stage of centrifugal compressor rotor blades 44. As is depicted, the core turbine engine 14 further includes a transition duct 46 immediately downstream of the compressor 22, the transition duct 46 having at least a portion extending generally along the radial direction R to provide a compressed air flow from the compressor 22 to the reverse flow combustor 24. The stage of centrifugal compressor rotor blades 44 are configured to assist with turning the compressed air within the compressor section radially outward into the transition duct 46. Notably, however, in other exemplary embodiments, the combustion section may not include the reverse flow combustor 24. With such an exemplary embodiment, the compressor 22 may not include the stage of centrifugal compressor rotor blades 44.

Additionally, between each stage of compressor rotor blades 42, 44, the compressor section includes a stage of compressor stator vanes. Notably, the first stage of compressor stator vanes is configured as a stage of variable compressor stator vanes 48, such that each of the variable compressor stator vanes 48 may rotate about a respective pitch axis 50. By contrast, the remaining stages of compressor stator vanes are configured as fixed compressor stator vanes 52. Such a configuration may assist with increasing an overall pressure ratio of the compressor 22. For example, the compressor 22 having the multiple number of stages of compressor rotor blades 42, 44, and optionally including a stage of variable compressor stator vanes 48, in addition to being located downstream of a stage of variable inlet guide vanes 38, may allow for the compressor 22 of the compressor section to operate in a more efficient manner. More specifically, for the embodiment depicted, the compressor section configured in accordance with one or more exemplary aspects of the present disclosure defines an overall pressure ratio of at least 15:1. For example, in certain exemplary embodiments, the overall pressure ratio of the compressor section may be at least 16:1. As used herein, the term “overall pressure ratio” refers to a pressure ratio of the compressor section during operation of the turboshaft engine 10 at a rated speed.

It will be appreciated, that during operation of the turboshaft engine 10, a volume of air 54 enters the turboshaft engine 10 through the radial inlet duct 20, and flows across the variable inlet guide vanes 38 and into the compressor 22 of the compressor section. A pressure of the air is increased as it is routed through the compressor 22, and is then provided to the reverse flow combustor 24 of the combustion section, where the air is mixed with fuel and burned to provide combustion gases. The combustion gases are routed through the HP turbine 26 where a portion of thermal and/or kinetic energy from the combustion gases is extracted via sequential stages of HP turbine stator vanes 56 that are coupled to the outer casing 18 and HP turbine rotor blades 58 that are coupled to the HP shaft 32, thus causing the HP shaft 32 to rotate, thereby supporting operation of the compressor 22. The combustion gases are then routed through the LP turbine 28 where a second portion of thermal and kinetic energy is extracted from the combustion gases via sequential stages of LP turbine stator vanes 60 that are coupled to the outer casing 18 and LP turbine rotor blades 62 that are coupled to the LP shaft 34, thus causing the LP shaft 34 to rotate, thereby supporting operation of the output shaft assembly 16. The combustion gases are subsequently routed through the exhaust section 30 of the core turbine engine 14.

Notably, for the embodiment depicted, the HP turbine includes at least two stages of HP turbine rotor blades 58. Such a configuration may ensure a sufficient amount of power is provided to the compressor 22 through the HP shaft 32. For the embodiment depicted, the HP turbine rotor blades 58 of the at least two stages of HP turbine rotor blades 58 are formed of a ceramic matrix composite material. Accordingly, the HP turbine rotor blades 58 may be capable of withstanding the relatively elevated temperatures within the HP turbine 26 without requiring a flow of cooling air to cool the HP turbine rotor blades 58.

As used herein, ceramic matrix composite material refers to a non-metallic material having high temperature capability. Exemplary CMC materials utilized for such components may include silicon carbide (SiC), silicon nitride, or alumina matrix materials and combinations thereof. Ceramic fibers may be embedded within the matrix, such as oxidation stable reinforcing fibers including monofilaments like sapphire and silicon carbide (e.g., Textron's SCS-6), as well as roving and yarn including silicon carbide (e.g., Nippon Carbon's NICALON®, Ube Industries' TYRANNO®, and Dow Corning's SYLRAIVIIC®), alumina silicates (e.g., Nextel's 440 and 480), and chopped whiskers and fibers (e.g., Nextel's 440 and SAFFIL®), and optionally ceramic particles (e.g., oxides of Si, Al, Zr, Y, and combinations thereof) and inorganic fillers (e.g., pyrophyllite, wollastonite, mica, talc, kyanite, and montmorillonite). For example, in certain embodiments, bundles of the fibers, which may include a ceramic refractory material coating, are formed as a reinforced tape, such as a unidirectional reinforced tape. A plurality of the tapes may be laid up together (e.g., as plies) to form a preform component. The bundles of fibers may be impregnated with a slurry composition prior to forming the preform or after formation of the preform. The preform may then undergo thermal processing, such as a cure or burn-out to yield a high char residue in the preform, and subsequent chemical processing, such as melt-infiltration with silicon, to arrive at a component formed of a CMC material having a desired chemical composition. In other embodiments, the CMC material may be formed as, e.g., a carbon fiber cloth rather than as a tape

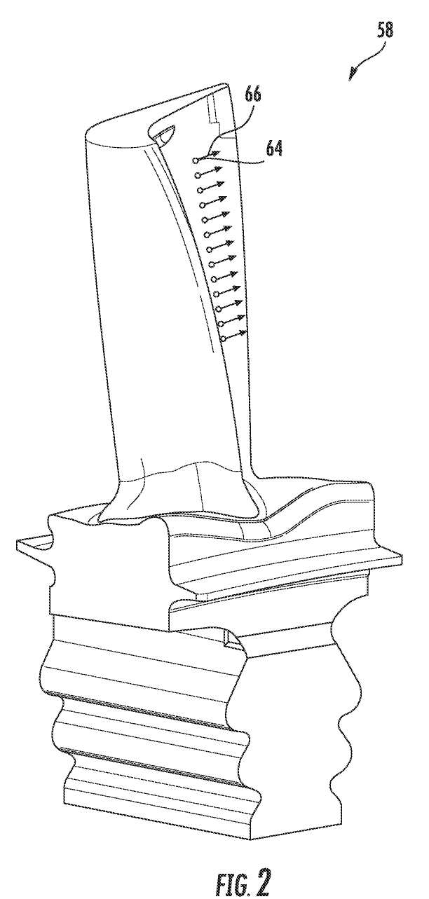

It should be appreciated, however, that in other exemplary embodiments, the HP turbine rotor blades 58 may be air cooled HP turbine rotor blades. For example, referring briefly to FIG. 2 providing a perspective view of an HP turbine rotor blade 58 in accordance with an exemplary embodiment of the present disclosure, the HP turbine rotor blade 58 may include a plurality of cooling holes 64 through which a cooling airflow 66 is provided during operation of the turboshaft engine 10 to maintain a temperature of the HP turbine rotor blade 58 below a predetermined temperature threshold.

Referring again to FIG. 1, as briefly stated, the LP shaft 34 is coupled to the LP turbine 28, and is further mechanically coupled to the drive shaft assembly 16. More specifically, the drive shaft assembly 16 includes a gearbox 68 and a driveshaft 70. The LP shaft 34 is mechanically coupled to the drive shaft 70 of the drive shaft assembly 16 through the gearbox 68. As will be appreciated, the driveshaft 70 maybe coupled to any suitable device. For example, in certain exemplary embodiments, the turboshaft engine 10 of FIG. 1 may be utilized to drive a propeller of a helicopter, may be utilized in aeroderivative applications, or may be attached to a propeller for an airplane, in which case the turboshaft engine may instead be referred to as a turboprop engine.

Moreover, it will be appreciated, that the turboshaft engine 10 depicted in FIG. 1 is a relatively small turboshaft engine 10. For example, the turboshaft engine 10 depicted may be rated to generate less than about 2,000 horsepower during peak operation and the compressor section (including the compressor 22) may have a nominal design of less than about 10.5 pounds per second of airflow. Notably, as used herein, “horsepower” refers to brake horsepower during standard day operating conditions, i.e., a horsepower delivered to the drive shaft assembly 16 by the LP shaft 34 during operation of the turboshaft engine 10 at sea level and with an ambient temperature of around seventy (70) degrees Fahrenheit. It should be appreciated, that as used herein, terms of approximation, such as “about” or “approximately” refer to being within a ten percent (10%) margin.

A turboshaft engine configured in accordance with the present disclosure, having a compressor section defining an overall compressor ratio as described herein, for the power class of engine described herein, may result in an overall more efficient gas turbine engine for the power class.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A gas turbine engine defining an axial direction and a radial direction, the gas turbine engine comprising:
a stage of variable inlet guide vanes;
a compressor section comprising a compressor located downstream of the stage of variable inlet guide vanes and defining an overall compressor ratio between 15:1 and 16:1 during operation of the gas turbine engine; and
a turbine section located downstream of the compressor section, the turbine section comprising a high pressure turbine and a low pressure turbine, the high pressure turbine comprising two stages of turbine rotor blades;
wherein the gas turbine engine generates less than 2,000 horsepower during peak operation; and
wherein the compressor of the compressor section comprises between three stages of radially oriented compressor rotor blades and four stages of radially oriented compressor rotor blades, and one stage of centrifugal compressor rotor blades.

2. The gas turbine engine of claim 1, further comprising:
a first spool coupling the compressor to the high pressure turbine; and
a second spool coupled to the low pressure turbine.

3. The gas turbine engine of claim 2, wherein the second spool is mechanically coupled to a drive shaft.

4. The gas turbine engine of claim 3, further comprising:
a gearbox, wherein the second spool is mechanically coupled to the drive shaft through the gearbox, and
wherein the gas turbine engine has an airflow of 10.5 pounds per second or less during peak operation.

5. The gas turbine engine of claim 1, wherein the compressor section further comprises a stage of variable stator vanes.

6. The gas turbine engine of claim 1, wherein the compressor of the compressor section comprises four stages of radially oriented compressor rotor blades.

7. (canceled)

8. The gas turbine engine of claim 1, wherein the overall compressor ratio of the compressor is 16:1 during operation of the gas turbine engine.

9. The gas turbine engine of claim 4, further comprising:
a combustion section comprising a reverse flow combustor.

10. The gas turbine engine of claim 1, wherein the turbine rotor blades of the two stages of turbine rotor blades of the high pressure turbine are air cooled turbine rotor blades.

11. The gas turbine engine of claim 9, wherein the turbine rotor blades of the two stages of turbine rotor blades of the high pressure turbine are formed of a ceramic matrix composite material.

12. The gas turbine engine of claim 11, further comprising:
a radial inlet duct located upstream of the compressor section.

13. A gas turbine engine defining an axial direction and a radial direction, the gas turbine engine comprising:
a compressor section defining an overall compressor ratio between 15:1 and 16:1 during operation of the gas turbine engine; and
a turbine section located downstream of the compressor section, the turbine section comprising a high pressure turbine and a low pressure turbine;
wherein the gas turbine engine generates less than 2,000 horsepower during peak operation; and
wherein the compressor of the compressor section consists of between four stages of compressor rotor blades and five stages of compressor rotor blades.

14. The gas turbine engine of claim 13, wherein the high pressure turbine comprises two stages of turbine rotor blades.

15. The gas turbine engine of claim 14, wherein the turbine rotor blades of the two stages of turbine rotor blades of the high pressure turbine are air cooled turbine rotor blades.

16. The gas turbine engine of claim 14, wherein the turbine rotor blades of the two stages of turbine rotor blades of the high pressure turbine are formed of a ceramic matrix composite material.

17. (canceled)

18. (canceled)

19. The gas turbine engine of claim 13, further comprising:
a first spool coupling the compressor to the high pressure turbine; and
a second spool coupled to the low pressure turbine, wherein the second spool is further mechanically coupled to a drive shaft.

20. The gas turbine engine of claim 13, further comprising:
a stage of variable inlet guide vanes, wherein the compressor section is located downstream of the stage of variable inlet guide vanes.
